(19) United States
(12) Patent Application Publication
(10) Pub. No.: US 2012/0188753 A1
(43) Pub. Date: Jul. 26, 2012

(54) DUAL CHARGING SYSTEM

(76) Inventors: Richard S. Popper, Scottsdale, AZ (US); Jensen Jorgensen, Kobenhavn (DK)

(21) Appl. No.: 13/355,074

(22) Filed: Jan. 20, 2012

Related U.S. Application Data
(60) Provisional application No. 61/434,857, filed on Jan. 21, 2011.

(51) Int. Cl. F21L 4/08; H02J 7/00

(52) U.S. Cl. 362/183; 320/107

(57) ABSTRACT

The invention relates to a dual charging system comprising a rechargeable unit and a charging station. The charging station comprises retaining means and a base part, said base part having a charging seat with a projecting peg acting as a first electrode, around which an at least partly circumferential second electrode is arranged. The rechargeable unit comprises a notch, acting as a third electrode, and a fourth electrode, said third and fourth electrode is each arranged on the rechargeable unit to engage with the first and second electrode respectively of the charging seat when the rechargeable element is retained in the charging station. Hereby an advantageous charging system is achieved ensuring correct positioning of the rechargeable unit in the charging station, even under unfavourable conditions.

### FIELD OF INVENTION

The present invention relates to a dual charging system comprising a charging station and a rechargeable unit.

### BACKGROUND OF INVENTION

From U.S. Pat. No. 5,459,389 a dual charging system is known. The system comprises a battery pack and a charger unit, which may be recharged by either plugging directly into a power main or by placement in the charger unit. The charging unit is a flat structure with a slight depression for receiving the battery back which requires that the charging unit is equipped with hooks to keep the battery pack properly positioned in the charger unit. These hooks however, makes the positioning of the battery pack in the charger unit more complicated as a specific insertion angle and twisting movement is required to position the battery pack. Also the movement needed to remove the battery pack from the charger unit is complex, which makes the action slow in order not to risk damaging the hooks. Furthermore, the insertion of the battery pack into the mains requires that a set of prongs are extended from the battery pack housing, which requires that the positioning of the battery pack is performed rather slowly in order to be sure that the prongs are extended the correct amount or else there is a risk that the battery pack will not be recharged. Additionally the retractable prongs make the battery unit complex and thus more prone to failure.

US 2007/0090789 describe a mobile device with dual charging ports. The device can be charged by a plug or by insertion in a charging seat. When recharged by the charging seat, the device specifically needs to be inserted along a predetermined direction in order to engage with the conductive terminals of the charging seat. Further there is an eminent risk that the conductive terminals will be damaged due to their design and placement perpendicular to a possible direction of insertion. Also, once the device is inserted it is, not, possible to see if the device is properly inserted to achieve electrical contact with the conductive terminals.

Thus there is a need for at system allowing reliable charging of a rechargeable unit under a variety of conditions. The unit must be easy to use and be sturdy and reliably even when used with swift movements.

### SUMMARY OF INVENTION

In a first aspect the present invention provides a charging system which ensures that a rechargeable unit can be charged under various conditions.

In a second aspect the present invention provides a charging system enabling swift insertion and removal of a rechargeable unit using only one hand.

In a third aspect the present invention provides a charging system which ensures a minimum risk of miss-alignment of the electrodes of the charging station and the rechargeable unit.

The above aspects together with other advantages are provided in that the dual charging system comprises a rechargeable unit and a charging station wherein

the charging station comprises retaining means and a base part, said base part having a charging seat with a projecting peg acting as a first electrode, around which an at least partly circumferential second electrode is arranged, and

the rechargeable unit comprises a notch, acting as a third electrode, and a fourth electrode, each arranged on the rechargeable unit to engage with the first and second electrode respectively of the charging seat when the rechargeable element is retained in the charging station.

When the rechargeable unit is arranged in the charging station, electrical contact is achieved between the first and third electrode and the second and fourth electrode respectively. The electrical contact between the electrodes allows an energy storage means, such as a rechargeable battery, in the rechargeable unit to be charged.

In the present application the phrase “correct position” is used of the positions of the rechargeable unit in the charging station in which the first and third, and second and fourth electrode engage allowing the rechargeable unit to be charged if desired.

A dual charging system according to the present invention as described above provides a safe charging function and arrangement, which allows easy use and minimizes the risk of achieving a wrong position of the rechargeable unit in the charging station.

When the first electrode is a peg projecting from a charging seat as in the present invention, it helps position the rechargeable unit. When the third electrode of the rechargeable unit is a notch, the third electrode may catch the first electrode during the movement when the rechargeable unit is inserted in the charging station, and thus enhance the chance of correct positioning even further.

Preferably the notch is an at least partly conical structure in which the slanting edges helps catch the first electrode and guides the first electrode to slide along the slanting edge to a correct position, in which electrical contact between the first and third electrode is achieved and maintained until the rechargeable unit is removed from the charging station or otherwise intentionally disengaged. The actual electrically conducting part of the third electrode may be arranged in the apex of the conical notch.

When an at least partly circumferential second electrode is arranged around the first electrode more than one correct positions of the rechargeable unit in the charging station is achieved. Having more than one correct position of the rechargeable unit in the charging station makes positioning of the rechargeable unit easier and thus possibly faster and with less risk of miss-alignment of the electrodes of the charging station and rechargeable unit with respect to each other.

Preferably the rechargeable unit is at least substantially cylindrical or has a similar shape with a high degree of symmetry in order to fit into the charging station in a number of different orientations. Other possible cross sections of the rechargeable unit than circular (as is the case for the cylindrical shape) are decagon, nonagon or hexagon or similar.

When the charging station comprises retaining means the rechargeable unit is kept in place in the charging station until intentionally removed. The retaining means ensures that electrical contact between the electrodes of the rechargeable unit and charging station is maintained. This means that the rechargeable unit can be charged by the charging station not only indoors but even if the charging station is not placed on a solid or steady surface for example if the charging station is arranged in a van, boat etc., which provides irregular and even rough movement of the charging station and rechargeable unit. Preferably the retaining means is arranged to allow removal and insertion of the rechargeable unit in a simple movement which does not require a much defined direction of insertion or removal and/or the retaining means may help guide the rechargeable unit to a correct position.

The retaining means also helps prevent that the rechargeable units is accidentally knocked out of the recharging station, and thus ensures that the rechargeable unit can be charged reliably by the charging station even in an area or in a place with a lot of activity as for example a workshop.

Furthermore, the charging station provides a secure and easy to find storage place for the rechargeable unit even when the rechargeable unit is not being charged.

The charging station according to the present invention may also comprise stabilising means such a weight position in the base part to increase the weight and lower the centre of mass of the charging station in order to enhance the stability and thereby prevent the charging station with or without the rechargeable unit to be tilted or completely knocked over.

The charging station may be arranged to hang on a wall or stand on a surface.

All in all, a dual charging system according to the present invention enables release of the rechargeable unit from the charging station and correct positioning of the rechargeable unit in the charging station, in a simple and effortless movement which may even be possible with one hand and without the full attention of a user. Release and removal of the rechargeable unit from the charging station is made possible and easy even under unfavourable conditions such as darkness or if the charging station is positioned in e.g. a hard to reach place, a moving vehicle or similar.

Preferably the rechargeable unit further comprises a socket for receiving a second charging means as this will make the charging system effective in even more situations. For example if charged by a plug with a cable a user is able to use the rechargeable unit while it is being charged. In some situations it may be handy to be able to charge the rechargeable unit without a charging station. Such situations can be during travel to avoid extra luggage or if the rechargeable unit is charged in an area where a charging station can not advantageously be installed.

The socket may be arranged to receive a one legged plug, or e.g. a USB or mini USB plug. The socket may also be configured to receive a special designed plug in order for the rechargeable unit to be charged by a specially designed item only to avoid destruction of the rechargeable unit.

The rechargeable unit can further comprise a seal or plug to engage with or over the socket for receiving the second charging means, when the socket is not in use. Such a seal or plug prevents that moisture or dust enters the socket, allowing safe use of the rechargeable unit even in e.g. rain, fog or snow without the risk of malfunction and damages to the rechargeable unit.

Preferably both of the charging station and the rechargeable unit contains one or more electrical circuits.

Preferably the rechargeable unit comprises a single circuit board which relates to both charging options, i.e. charging by charging station and by plug.

An advantageous arrangement of the charging station is achieved if the first electrode is arranged as a centre point around which the second electrode is arranged as a circular element or at least one circle section element. If the first electrode is positioned in a central position in the charging seat there may be a number of optimal “curves” of insertion as the central position allows a high degree of symmetry and hereby enhance the chance of correct positioning of the rechargeable unit in the charging station. The positioning is made even easier if the second electrode is arranged around the first electrode as one or more circle sections as the number of correct positions of the rechargeable unit in the charging station is further increased. The number of correct positions is maximized if the second electrode is a circular element arranged around the first electrode due to the up to 360° symmetry of the arrangement.

In general, arrangements of the charging station where the second electrode is rotational symmetric around an axis defined by the first electrode perpendicular to the charging seat can be advantageous due to the fact that the rechargeable unit will be positioned correctly in a number of different orientations and no single correct position exists. Having more than one correct positions greatly decrease the risk of miss-alignment of the first and third, and especially the second and fourth electrode with respect to each other. Rotational symmetry can be achieved by one or more circle sections but also from other more irregular shapes or e.g. by a hexagonal shape or a number of chevrons arranged “shoulder to shoulder” or apart together forming the circumferential second electrode.

A preferred embodiment of the present invention is achieved if the second electrode is magnetic and the fourth electrode is magnetic or magnetisable, or vice versa as this may help correct positioning of the rechargeable unit in the charging station. If for example the second electrode is arranged as a circle section covering a certain angular area around the first electrode and said second electrode is magnetic, it may by magnetic interaction pull a magnetic or magnetisable fourth electrode to a correct position where there is electric contact between the first and third and second and fourth electrode respectively. It is also possible that the second electrode is magnetisable and the fourth electrode is magnetic.

In yet another preferred embodiment the retaining means is arms or a C- or U-shaped elastic element which allows the rechargeable unit to be pushed in and pulled out through the opening between the arms or in the C- or U-structure. The elasticity can be achieved by the design of the arms of the C- or U-shaped structure, which for example may be thin enough to be flexible or made from a rubber or plastic material which provides elasticity even if the structure of the arms, C- or U-shape is quite heavy and/or sturdy. When the rechargeable unit may be inserted not only from the top as will be the case if the retaining means are O shaped but also through for example the front of the charging station through the opening between the arms or in the C- or U-shaped structure the rechargeable unit may be inserted and released fast and precise without the risk of damaging either the electrodes, the retaining means or any other part of the charging station. The opening between the arms or in the C- or U-shaped structure of the retaining means may help guide the rechargeable unit to a correct position.

The retaining means may also be another structure through which the rechargeable unit may be inserted.

The rechargeable unit may be inserted through an opening in the retaining means, preferably with the application of a force as e.g. a slight push. The retaining means may be arranged in order for them to help keep the rechargeable unit it place in the charging station during a number of different conditions e.g. even if the charging station is pushed over, or shaken heavily.

If the retaining means is arranged to hug the rechargeable unit positioned in the charging station, it is prevented that the rechargeable units is partly or completely knocked out of its intended position in the charging station during charging.

The retaining means may also be one or more magnetic elements preferably arranged at least as or as part of the second electrode, but can also be arranged in all of or part of the base of the charging station, in at least a part of a possible wall part of the charging station or even in retaining means such as the C or U shaped structure described above. The surface of a magnetic element may be free or the magnetic element may be embedded in the structure of the charging station. As described above, if the second electrode is magnetic it may not only act as a retaining means, but may also help correct positioning of the rechargeable unit in the charging station by pulling the fourth electrode towards itself by magnetic interaction.

In a preferred embodiment the rechargeable unit is arranged in a flashlight, preferably in the end opposing a light emitting part. The rechargeable unit may be releasable from the flashlight, which e.g. enables the use of a rechargeable unit with different flashlights or to have a number of rechargeable units for a single flashlight. Preferably the rechargeable unit is an integrated part of the flashlight, in which case the flashlight itself may be regarded as the rechargeable unit. When the rechargeable unit is integrated in a flashlight it makes the structure of the flashlight/rechargeable unit sturdy without the risk of the rechargeable unit being unintentionally released from the flashlight during even rough or heavy use or transport.

The rechargeable unit may also be arranged in other devices such as e.g. power tools or toys in which case the same arguments as presented for the flashlight apply with respect to the releasable and integrated configurations respectively.

Preferably the flash light contains at least one LED as a light source as LEDs can provide high light intensity and long life for both a power source, which in the present case is a rechargeable unit, and light source.

The charging station and the rechargeable unit is not only useful together but also on their own. The descriptions and many advantages of both the charging station and the rechargeable unit given above are valid for the rechargeable unit and charging station alone or together.

### DESCRIPTION OF DRAWINGS

In the following the present invention will be described further by reference to the drawings. The illustrated embodiments are however only exemplary and are not to be construed as limiting to the present invention.

FIG. 1 shows a dual charging system according to the present invention in which the rechargeable unit is an integral part of a flashlight,

FIG. 2 shows a charging station according to the present invention seen in a perspective view from above,

FIG. 3 shows a rechargeable unit integrated in a flashlight seen in perspective from the end containing the third and fourth electrode,

FIGS. 4a and 4b shows exemplary configurations of the first and second electrodes in a charging seat,

FIGS. 5a and 5b shows exemplary configurations of the third and forth electrode of the rechargeable unit along with the socket for receiving a second charging means, and

FIG. 6 shows a simplified cross section of the rechargeable unit of FIG. 5b taken along the XI-XI direction.

### DETAILED DESCRIPTION OF THE INVENTION

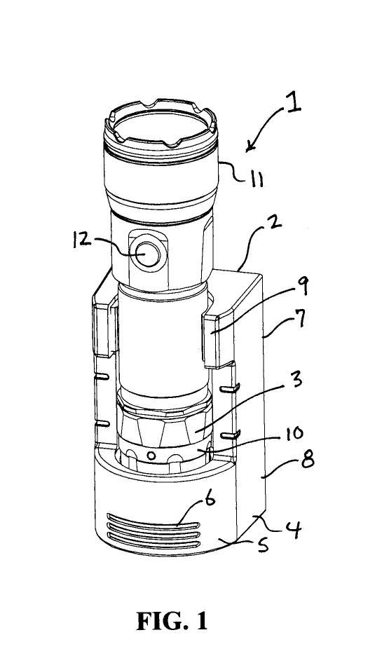

FIG. 1 shows a dual charging system 1 according to the present invention. The system 1 has two main parts, a charging station 2 and a rechargeable unit 3, in the present example in the form of a flashlight. The charging station 2 has a base part 4 with a rounded front 5 having a number of optional grooves 6. The charging station 2 further contains an upright part 7 extending from a rear part 8 of the base part 4. The upright part 7 is provided with retaining means in form of two arms 9 arranged to slightly hug the rechargeable unit 3 when arranged in the charging station 2 in order to keep the rechargeable unit 3 correctly positioned in the charging station 2. The rechargeable unit 3 comprises a first end 10 engaging in the charging station 3 and a second end 11 opposing said first end 10. The second end in the present example contains a LED light source (not shown). The rechargeable unit 3 also comprises a switch 12 for turning the flashlight on and off.

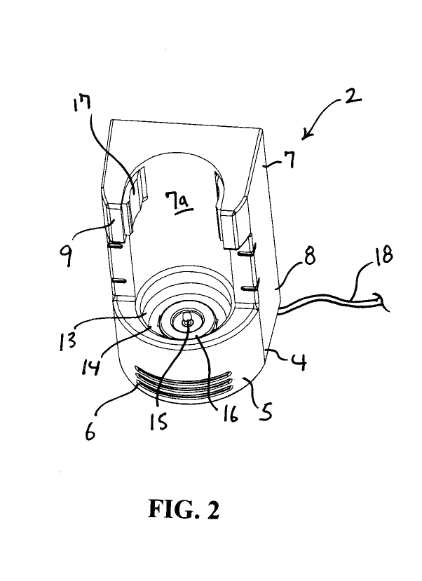

FIG. 2 shows the charging station 2 from FIG. 1 seen in perspective from above. For like parts same numerals are used. A charging seat 13 is depressed in the base part 4 of the charging station 2. The charging seat 13 is circular with a substantially flat bottom 14. Placed centrally in the charging seat 13 is a first electrode 15 which in the present example is a cylindrical peg with a ball shaped head. Concentric around the first electrode 15 is a circular second electrode 16, which in the present example is slightly raised from the bottom 14 of the charging seat 13, but may as well be leveled with the bottom 14. The two arms 9 arranged to retain a rechargeable unit in the charging station 2 are each provided with an inner element 17 two help grasp the rechargeable unit 3. Together the arms 9 form a U shape and with the inner elements 17 a slight C shape. The inner elements 17 may be omitted if the arms 9, or similar retaining means, alone are capable of retaining the rechargeable unit 3 in the charging station 2.

In the present example an inner wall 7a of the upright part 7 is rounded to fit the curvature of the belonging rechargeable unit (not shown). Together the charging seat 13, inner wall 7a and the arms 9 forms a cavity for receiving the rechargeable unit (not shown).

The charging station also comprises a cable 18 for providing electrical connection to the charging station 2.

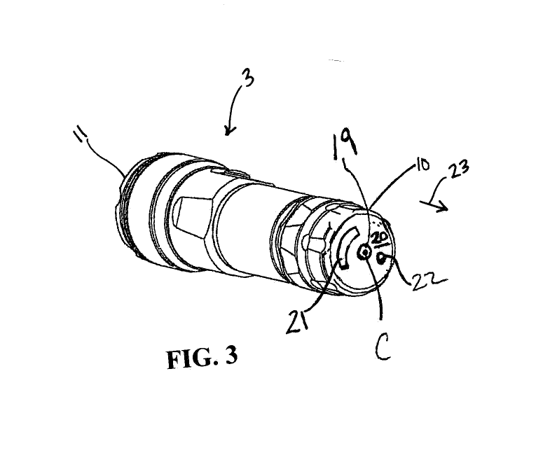

FIG. 3 shows the rechargeable unit 3 seen in perspective from the first end 10. A central third electrode 19 is arranged in an at least substantially flat surface 20 of the first end 10 of the flashlight/rechargeable unit 3. The surface 20 is arranged to abut the charging seat 13 of the charging station 2. The third electrode 19 of the present example is a conical notch with the apex in the centre C of the surface 20. The surface 20 also comprises a fourth electrode 21 which in this exemplary embodiment is a circle section spanning approximately 90°. In the surface 20 is also arranged a socket 22 for receiving a second charging means 23.

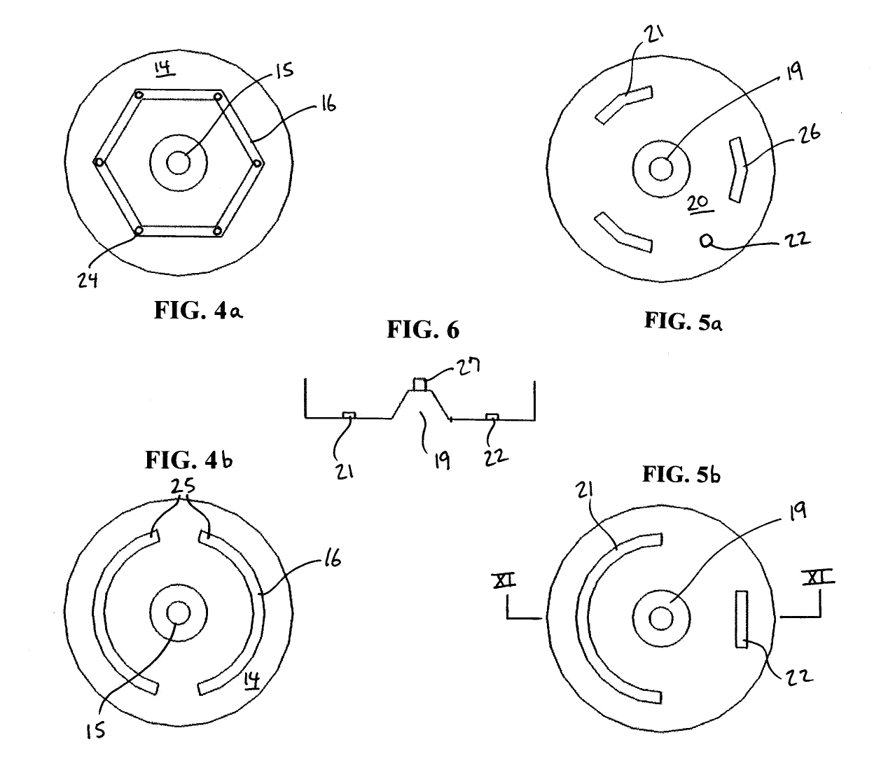

FIGS. 4a and 4b show two different exemplary configurations of the first and second electrode of a charging station according to the present invention. In 4a a hexagonal second electrode 16 is arranged around a central first electrode 15. The hexagonal second electrode may be simple or e.g. be arranged with magnets in all corners as indicated by circles 24. The second electrode may also be completely of a magnetic or magnetisable material.

FIG. 4b shows a charging seat with a central first electrode 15 surrounded by two crescent shaped elements 25 together forming the second electrode.

FIGS. 5a and 5b shows two different exemplary configurations of the third and fourth electrode of a rechargeable unit as known from FIGS. 1 and 3 and according to the present invention.

In FIG. 5a a surface 20 of a rechargeable unit 3 is seen. The third electrode 19 is a central conical notch and the fourth electrode 21 consists of three chevrons 26 arranged encircling the third electrode. A socket 22 for receiving a simple jack plug is also comprised in the surface 20.

In the surface 20 of FIG. 4b a crescent shaped fourth electrode 21 is arranged around a third electrode as known from the previous figures. The surface 20 also comprises a mini USB port 22 for receiving a mini USB plug acting as the second charging means.

FIG. 6 is a simplified cross section along the direction XI-XI in FIG. 5b to visualize the conical shape of the third electrode 19. The actual conducting element 27 of the third electrode may be present in the apex of the cone.

In the above examples one or more of the electrodes, and preferably the second and fourth electrode, may be magnetic and/or magnetisable.

Thus, according to the present invention is provided a dual charging system with a number of advantages over prior art making it useful in a variety of situations from office use to active situations e.g. in moving vehicles. The rechargeable unit according to the present invention may be charged by use of the charging station according to the present invention or by a simple charger with a wire and plug. The charging station provides safe storage and reliable charging of the rechargeable unit, as it is arranged to allow easy insertion and removal of the rechargeable unit and to keep it in a desired position. The rechargeable unit is arranged to be easily inserted in and removed from the charging station and especially the electrodes are arranged to ensure correct alignment with the electrodes of a charging station according to the present invention. The option of charging by plug, and not by the charging station, makes the dual charging system and rechargeable unit on its own useful even under circumstances where the charging station may be unhandy.

1. Dual charging system comprising a rechargeable unit and a charging station, wherein
the charging station comprises retaining means and a base part, said base part having a charging seat with a projecting peg acting as a first electrode, around which an at least partly circumferential second electrode is arranged, and
the rechargeable unit comprises a notch, acting as a third electrode, and a fourth electrode, said third and fourth electrode is each arranged on the rechargeable unit to engage with the first and second electrode respectively of the charging seat when the rechargeable element is retained in the charging station.

2. Dual charging system according to claim 1 wherein the rechargeable unit further comprises a socket for receiving a second charging means.

3. Dual charging system according to claim 2, wherein the first electrode is arranged as a center point around which the second electrode is arranged as a circular element or at least one circle section element.

4. Dual charging system according to claim 3 wherein the second electrode is rotational symmetric around an axis defined by the first electrode perpendicular to the charging seat.

5. Dual charging system according to claim 4 wherein the second electrode is magnetic and the fourth electrode is magnetic or magnetisable, or vice versa.

6. Dual charging system according to claim 5 wherein the retaining means is arms, a C- or U-shaped elastic element and/or one or more magnetic elements.

7. Dual charging system according to claim 6 wherein the rechargeable unit is arranged in a flashlight, preferably in the end opposing a light emitting part.

8. Dual charging system according to claim 7 wherein the flashlight contains at least one LED as a light source.

9. A charging station comprising retaining means and a base part, said base part having a charging seat with a projecting peg acting as a first electrode, around which an at least partly circumferential second electrode is arranged.

10. A charging station according to claim 9, wherein the first electrode is arranged as a center point around which the second electrode is arranged as a circular element or at least one circle section element.

11. A charging station according to claim 10, wherein the second electrode is rotational symmetric around an axis defined by the first electrode perpendicular to the charging seat.

12. A charging station according to claim 11, wherein the second electrode is magnetic and the fourth electrode is magnetic or magnetisable, or vice versa.

13. A charging station according to claim 12, wherein the retaining means is arms, a C- or U-shaped elastic element and/or one or more magnetic elements.

14. A rechargeable unit for use with the charging station, said rechargeable unit comprising a notch, acting as a third electrode, and a fourth electrode, said third and fourth electrode is each arranged on the rechargeable unit to engage with the first and second electrode respectively of the charging seat when the rechargeable element is retained in the charging station.

15. The rechargeable unit according to claim 14 which further comprises a socket for receiving a second charging means.

16. The rechargeable unit according to claim 15 arranged in a flashlight, preferably in the end opposing a light emitting part.

17. A rechargeable unit according to claim 16 wherein the flashlight contains at least one LED as a light source.
